(19) United States
(12) Patent Application Publication
(10) Pub. No.: US 2025/0207333 A1
(43) Pub. Date: Jun. 26, 2025

(54) INSULATION PANEL FOR SHIPPING CARTONS AND METHOD OF MANUFACTURING THEREOF

(71) Applicant: Simple Container Solutions, Inc., Rancho Dominguez, CA (US)

(72) Inventor: Charles S. VEISEH, Los Angeles, CA (US)

(21) Appl. No.: 18/975,335

(22) Filed: Dec. 10, 2024

Related U.S. Application Data
(60) Provisional application No. 63/612,473, filed on Dec. 20, 2023.

(51) Int. Cl. D21H 21/18; B32B 29/00; B32B 37/18; B65D 5/50; B65D 81/38; D21H 17/28; D21H 27/00; D21H 27/10; D21H 27/38

(52) U.S. Cl. CPC D21H 21/18; B32B 29/005; B32B 37/18; B65D 5/5035; B65D 81/3823; D21H 17/28; D21H 27/002; D21H 27/10; D21H 27/38; B32B 2255/12; B32B 2255/26; B32B 2307/31; B32B 2317/12; B32B 2553/00

(57) ABSTRACT

A method for producing insulation panels for shipping cartons, comprising narrowing a web of tissue paper selected from cellulosic or synthetic tissue paper, having an initial volume and thickness, to increase the volume and thickness of the web, thereby forming narrowed tissue paper web, sectioning a desired length of the web and enveloping such a narrowed structure with a paper material with lesser absorbency than the tissue paper.

### FIELD OF THE INVENTION

The present invention describes insulation panels for shipping cartons and their manufacture. In particular, the present invention relates to recyclable insulation panels using narrowed cellulosic tissue paper.

### BACKGROUND

Insulated box liner panels utilizing embossed paper materials or paper materials modified to increase volume and/or enhance insulation characteristics, or unmodified tissue or paper used as a filler, exist in the market today, however, they are difficult to produce and present cost inefficiency since paper and tissue stock materials are flat and don't exhibit natural bulkiness or loft forming tendency. They also result in a soft panel when used as a filler that is not desirable to some users. Additionally, embossing applied to tissue has a limited effect in increasing a desirable loft, which if achieved improves insulation performance, improves cushioning and increases material efficiency. Paper materials such as embossed tissue paper, processed to be utilized as insulation panels, exhibit characteristics that are relatively soft-feeling when compared to traditional insulation panels such as expanded polystyrene and polyurethane foam. They also lack the stiffness to retain their embossed format.

In a cold chain shipping application, where lining cartons with insulation panels, it can be advantageous to have firm, angular edges. Such geometry provides more contact area where panels abut, reducing air flow at seams and providing a more aesthetically pleasing appearance for the goods shipped to recipients. Firmer panels are also more suitable for heavy payloads that can cause deflection on a softer panel during shipment which can in turn, introduce heat loss along the edges of the panels where they abut. Finally, an insulation panel that is more expansive, with lower density and/or more loft, presents more, firmer encapsulated spaces that result in better insulation performance.

For this reason, a low-cost method to create a panel with stiffened tissue or paper structure results in lofty insulation panels that maintain this stiffness during use is needed in the marketplace. Such an applied method preferably does not render such a material non-recyclable.

### SUMMARY OF THE INVENTION

In one embodiment, the present disclosure provides a method for producing insulation panels for shipping cartons, comprising: narrowing a web of tissue paper selected from cellulosic or synthetic tissue paper, having an initial volume and thickness, to increase the volume and thickness of the web, thereby forming narrowed tissue paper web, sectioning a desired length of the web and enveloping such a narrowed structure with a paper material with lesser absorbency than the tissue paper. A pre-embossed tissue or tissue paper treated to increased volume can be utilized for further performance enhancement.

In another embodiment, the present disclosure provides a method for producing insulation panels for shipping cartons, comprising:
narrowing a web of tissue paper selected from cellulosic or synthetic tissue paper having an initial volume and thickness to increase its volume and thickness, thereby forming narrowed tissue paper web, having an initial firmness;
optionally pre-drying said treated tissue paper to a final moisture level of 0.1-0.6% (to maximize absorption of a desirable solution);
treating the narrowed tissue paper with a stiffening agent to increase firmness, thereby forming a treated tissue paper having a form, stiffness, and a firmness a minimum of 10% greater than the initial firmness; and
drying said treated tissue paper to a final moisture level of 0.5 to 6.5%, while retaining its form and stiffness, thereby forming a dried, treated tissue paper having a top surface and a bottom surface.

This invention seeks to address the current challenges in the market by providing a cost-effective, lightweight, and recyclable insulation panel for shipping cartons. The described method ensures firm, memory-retaining panels that reduce shipping costs and promote sustainability.

### BRIEF DESCRIPTION OF THE DRAWINGS

The subject matter of the present disclosure will be more fully understood from the following detailed description, taken in connection with the accompanying drawings, in which:

FIG. 1 shows a multilayer tissue paper web passed through a narrowing mechanism.

FIGS. 2A-B show a web structure having narrowed, thickened tissue paper layers.

FIG. 3 illustrates spraying structures with starch dissolved in water to enhance the product stiffness.

FIG. 4 illustrates the application of heat to dry the material and set the starch.

FIG. 5 shows the structure having paper applied to both top and bottom sides.

FIG. 6 shows a top view panel wrapped with paper and creased.

FIG. 7 shows a flat multi-layer tissue on a flat surface.

FIG. 8 shows narrowed multilayer tissue, soaked with starch solution, wet.

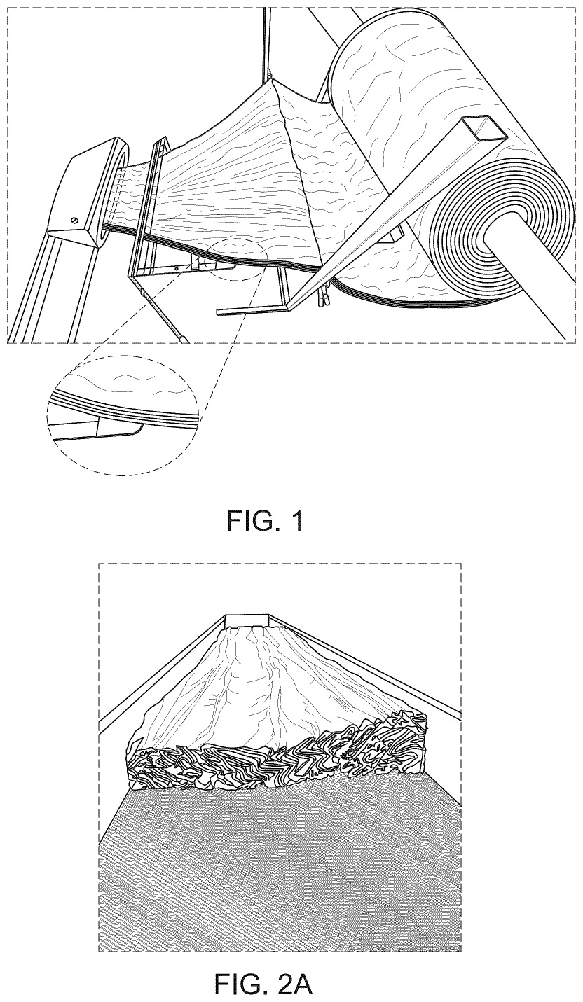

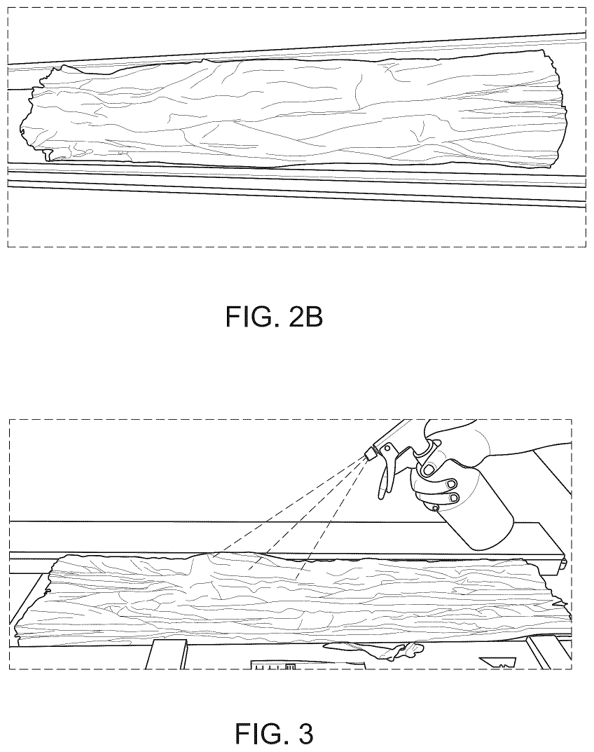

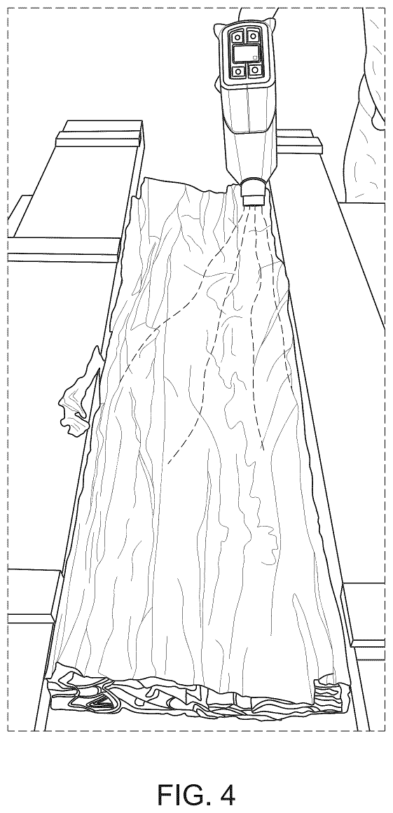

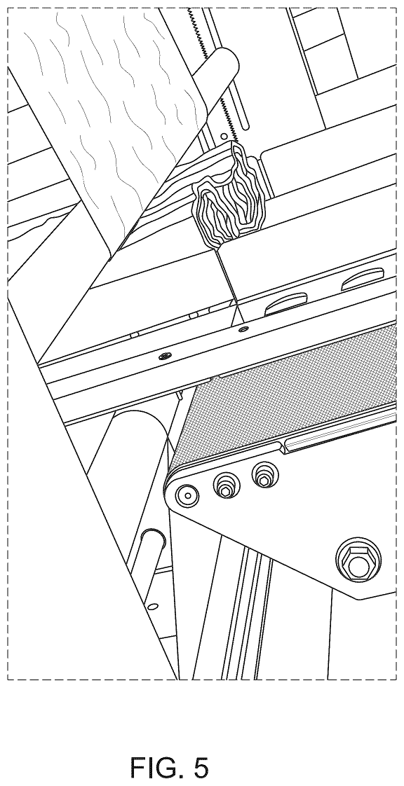

### DETAILED DESCRIPTION OF THE INVENTION

The subject matter of the present disclosure provides an improved method for producing insulation panels for shipping cartons. In one embodiment, the present disclosure provides a method for producing insulation panels for shipping cartons, comprising: narrowing a web of tissue paper selected from cellulosic or synthetic tissue paper, having an initial volume and thickness, to increase the volume and thickness of the web, thereby forming narrowed tissue paper web, sectioning a desired length of the web and enveloping such a narrowed structure with a paper material with lesser absorbency than the tissue paper. A pre-embossed tissue or tissue paper treated to increased volume can be utilized for further performance enhancement.

In another embodiment, the present disclosure provides the present disclosure provides a method for producing insulation panels for shipping cartons, comprising: narrowing a web of tissue paper selected from cellulosic or synthetic tissue paper having an initial volume and thickness to increase its volume and thickness, thereby forming narrowed tissue paper web, having an initial firmness; optionally pre-drying said treated tissue paper to a final moisture level of 0.1-0.6% (to maximize absorption of a desirable solution); treating the narrowed tissue paper with a stiffening agent to increase firmness, thereby forming a treated tissue paper having a form, stiffness, and a firmness a minimum of 10% greater than the initial firmness; and drying said treated tissue paper to a final moisture level of 0.5 to 6.5%, while retaining its form and stiffness, thereby forming a dried, treated tissue paper having a top surface and a bottom surface.

### Insulation Panel Production Process

### Tissue Paper

In the panels described below for thermal packaging, tissue paper is preferred, where the tissue paper can be selected from cellulosic or synthetic paper. Cellulosic material is preferred. Exemplary tissue paper is commercially available from manufacturers such as Kimberly Clark and used in applications such as facial or commercial napkin material. Ideal tissue paper is typically available in 12 to 18 pound varieties. Any weight of tissue material can be suitable for application for this invention.

In today's thermal packaging marketplace, cellulosic materials are used for insulation panels based on the recyclability of the finished product. Preferably, all components, including stiffening agents and adhesives, are water-soluble or otherwise pulpable.

The primarily paper construction of the article, when used in conjunction with water-soluble stiffeners yields a liner that is largely recyclable where recyclers use a process that first transforms the recycled item to a pulp material that is later turned into more paper materials. Although recyclability of a material can change from time to time due to market demands for a particular grade of material, less-processed cellulose materials are preferred in that they consist of longer cellulose fibers that are more desirable to recycling facilities. For the purpose of this specification, the term less-processed cellulose materials means cellulose material that has been through one or fewer recycling processes. Longer cellulose fibers provide greater strength to products manufactured using them and are therefore more desirable for and graded higher by recyclers. Comparatively, products made using macerated newsprint which consists of shorter fiber cellulose material of lesser value when graded by recyclers and are possibly sent to landfills instead of being recycled. Preferably, to be recyclable, the average fiber length of the pulped fiber is 0.7 to 3.2 mm. More preferably, the average fiber length of the resultant pulped fibers produced in the recycling process is from 0.824 to 3.2 mm. When the pulped fiber is tissue material, the average fiber length of the pulped fiber is more preferably from 1.0 to 3.2 mm. When the pulped fiber is not tissue material the average fiber length is more preferably from 0.824 to 0.744 mm. To be recyclable, preferably, the average fiber width of the pulped non-tissue fibers are from 20.8 to 19.8 μm, and preferably, the fiber shape factor of the pulped non-tissue fibers is from 90.1 to 89.3. The average fiber length, average fiber width and fiber shape factor are as described in Recycling of the Hardwood Kraft Pulp, Geffertova et al, Technical University in Zvolen, Faculty of Wood Sciences and Technology, March 2012, www.intechopen.com, p 270-275.

Preferably, the materials of construction of the panels are substantially recyclable. More preferably, they are fully recyclable. Most preferably, they are perfectly recyclable. For the purposes of this specification, the term recyclable refers to the recycling of cellulose-based material such as paper, paper-products or tissue. For the purposes of this specification, the term substantially recyclable means that greater than 50 wt % of the material for recycling is recyclable as defined below. The term fully recyclable means that essentially all (e.g., greater than 85 wt %) of the desired recycled material with the exception of stiffeners, adhesives and non-pulpable added materials is available for recovery in the recycling process. Perfectly recyclable means that 100 wt % of the desired recycled material is available for recovery with the exception of additives. For example, in the instance that a mixture of plain paper and pieces of plastic are fed to a paper recycling process, the plastic can be removed from the mixture by standard separation techniques without substantial loss of the desired paper. The stream is thus recyclable because although contaminant material is present in the stream, that can be removed without loss of the desired pulp which is available for recovery. In another example, the stream contains plain paper as well as paper cups that have been coated with a polymer or other materials to make the cup leak-proof. The nature of the coating is such that the paper in the cups cannot be separated from its coating using reasonably cost-effective means. Thus, the paper cups must be discarded probably in a landfill, and the stream is not fully recyclable. Also, the absence of ‘stickies’ in the article is critical. “Stickies” are materials derived from such materials as non water soluble adhesive that can gum up and interfere with the recycling process. The term recyclable additionally means that the pulp material is of sufficient quality to meet the requirements of recycling centers. This includes having fiber lengths meeting particular dimension requirements as described below. Thus, if the fiber length is too short, the material may not be recycled. A critical factor is a ratio of preferably a minimum of 80% or greater of total weight fiber content to 20% or less non-fiber content of the article.

### Narrowing

The cellulosic material, e.g., multi-layer tissue paper, is preferably first dried to remove any water absorbed into the fibers before treatment. A web of cellulosic material, preferably tissue paper, is fed into a system where it undergoes a narrowing process, effectively narrowing it to a wavy or pleated structure with pockets of air and improved loftiness, enhancing its insulating properties. Typically, the cellulosic material is narrowed using a narrowing orifice or forming device that forces a reduction in width of a web of material as it is fed through. This can be achieved with a powered or non-powered unwind that dispenses the web of material. This paper material is then pulled through the device using powered pinch rollers on the opposite side of the device. A 50% reduction in overall width produces favorable results although greater reduction up to 80% provides better loftiness and insulating performance. The random nature of the narrowing is a benefit in that in a preferred method when multiple individual layers of tissue are narrowed and stacked so as to enhance overall thickness, the irregular structure prevents nesting of the ‘waves’ further enhancing the loftiness of the stacked structure.

### Stiffening Treatment

The narrowed material is then treated, preferably by soaking with a solution containing a stiffening agent like potato or corn starch dissolved in water or another solvent. This step allows the stiffening agents to be introduced into the fibers of the tissue layers. Various water-soluble stiffeners can be employed to enhance the material's rigidity and overall properties. Starches and Modified Starches stand as one of the oldest and most prevalent stiffeners. They can undergo chemical or physical modifications to bolster their performance. Another notable stiffener is Carboxymethyl Cellulose (CMC), a water-soluble cellulose ether derivative.

Stiffening agents can also include natural gums, like guar gum, xanthan gum, and locust bean gum. Other stiffening agents include polyvinyl alcohol (PVA), a synthetic polymer, and polyacrylamides, and gelatin, a protein derived from animal collagen. From the marine world, chitosan, derived from crustacean shells, acts as a stiffener with the added advantage of its antibacterial properties. Similarly, alginate, extracted from brown seaweed, can be used. Polyethylene Oxide (PEO) also contributes to fiber binding, subsequently elevating the paper's strength and rigidity. Finally, water-soluble cellulose ethers like methyl hydroxyethyl cellulose (MHEC) and Hydroxyethyl Cellulose (HEC) can be incorporated as stiffeners in specific papermaking processes.

The agents are typically in a solution since absorption into the tissue is key importance. With respect to a pure potato starch and water solution, after 3% the solution becomes non-sprayable. Evaporable solvents, such as those that evaporate more quickly than water, such as ethanol, can be used as well which may preclude or reduce the need for an active drying method such as blown air.

The ratio of lb-stiffening agent/lb-material is defined by the amount of starch i.e. viscosity, however, a full soaking of the tissue. It should be noted that not all layers of tissue must be soaked for full effect and emphasis should be on outer layers and/or most exposed layers and/or surfaces.

### Drying

This treated material is then rapidly dried, while maintained in narrowed format, preferably, using forced air high heat. The drying process is designed to ensure the material retains its narrowed shape and firmness. Other forms of drying cannot include solely surface heating/pressing, ironing, infrared, microwave, centrifugal force, heat lamps. These are either too slow or won't achieve the desired results. Staged drying, however, can be used wherein a blown hot air method is first used then when excess water is removed, a secondary method such as infrared heating or other method is used for achieving final results.

Temperatures above 220° F. are preferred, although unheated air can produce drying. More preferably, the heating temperature is between 220 F and 705 F and the heating time is between 0.01 and 3 seconds. Final moisture levels of the material is between 0.5 to 6.5%.

Optionally, a sheet of material can be adhered to one or both surfaces of the narrowed, final dried material to provide a flat surface with geometric edges. This addition also offers better insulation properties, as it reduces heat flow by introducing additional layers of material that block air flow and by providing more geometric edges for the panels that abut when the panels are assembled inside a carton.

Further, a reflective material may be installed on a surface or between the layers of the narrowed tissue. The reflective material can be unattached to the narrowed tissue. The covered, narrowed material can be creased using pressure and/or heat to facilitate bending of the panel when inserted into a shipping carton.

The finished panel is then sectioned and wrapped, preferably with a heat-sealable paper. This wrapping not only improves aesthetics but also offers better protection to the goods packed inside by preventing transfer of the payload with the contents of the panels and vice versa or otherwise preventing contamination of the goods being packaged. The heat sealable paper can be selected from chemically-treated paper and polyethylene coated paper, where the term chemically treated means chemicals that allow the paper to adhere to another material when heat and/or pressure are applied. Polyethylene coated papers or chemically treated papers for water resistance, may provide a superior covering material in that their extra water resistance, as compared to papers not treated for water resistance, help to protect the insulation material from moisture that contacts it such as that from condensation inside the box or on the payload. Although paper is a preferred wrapping material that can enhance recyclability and or improve cosmetic appearance, plastic materials can also be used to wrap the panels. Any material that protects the interior material is suitable. A full wrapping however, is unnecessary i.e. one or both surfaces of the narrowed material can be attached to a less absorbent material while one or more edges of the panel remain exposed.

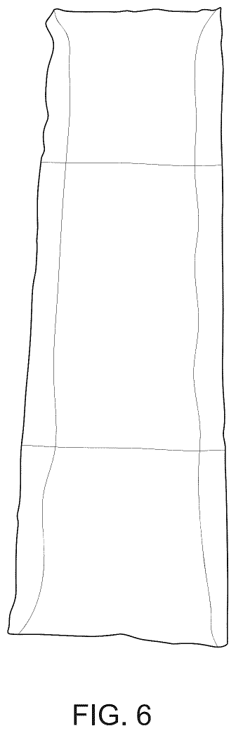

Creasing can be applied to the panels thereafter to enhance the bending of the panels when inserted into the shipping cartons (See FIG. 6). Such creasing can be achieved preferably using heated bars or alternatively using pressure only. Preferably the bar temperature used to apply the crease is between 200 F and 451 F.

### Recyclability

The insulation panels are preferably curbside recyclable and pulpable. For the purposes of this specification the term curbside recyclable means 80% or greater paper content. The term pulpable means that the paper material can be dissolved into loose fiber in water. Alternately, from 75 to 84% of fiber in the cellulosic material can be reclaimed when introduced into a recycling process. Preferably, in the insulation panel, every component contains cellulose fiber, even if it is coated or treated with other material. Preferably, the entire structure of the insulation panel may have a non-pulpable material such as a sheet of metalized polyester added to enhance performance. This does not render a component of the insulation panel non-recyclable since the non-pulpable material is filtered out during recycling. Also, the processes of narrowing are reversible using such means as heating and or moistening of the narrowed, treated materials.

### Products Using the Insulation Panels

The insulation panels described above can be used in a shipping carton. Preferably, the shipping carton is a paper shipping carton. The insulation panels can also be used to produce cushioning materials for transportation or generally as insulation panels.

### EXAMPLES

The following Examples further detail and explain the claimed process for producing improved insulation panels for shipping cartons. Those skilled in the art will recognize many variations that are within the spirit of the invention and scope of the claims.

### Example 1

Deflection testing was performed on five panels with varying levels of starch treatment. Each panel is an unwrapped CelluLiner liner with 10 machine narrowed layers of embossed tissue paper. The nominal panel size of sample is 26″×10.25″. Each sample was removed from the device, placed between two properly spaced planks of wood, and then sprayed with a mixture of 25%, 50%, 75%, or 100%, by volume, Purex Sta-Flo Concentrated Liquid Starch. The one exception is the 0% Sta-Flo which was not sprayed and was tested as is. Once completely sprayed on five sides, ensuring to expose the sides pressed against the wooden guides and sprayed before returning them to their previous position, the panel was dried with a 800° F. heat gun for about 3 seconds per section in range of heat blower. Better results are generally achieved with faster air and hotter air up to 1500 F. Once dry, the panel was flipped over, and the process was repeated on the backside. The fully dried panels were then ready for testing.

### Experiment 2

### Conceptual Density Reduction

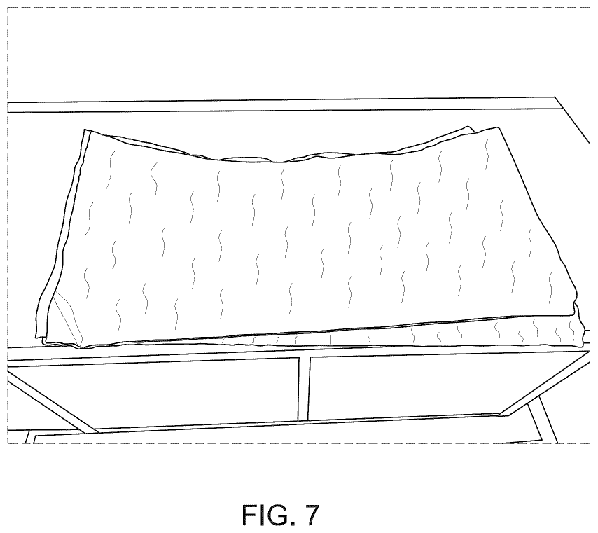

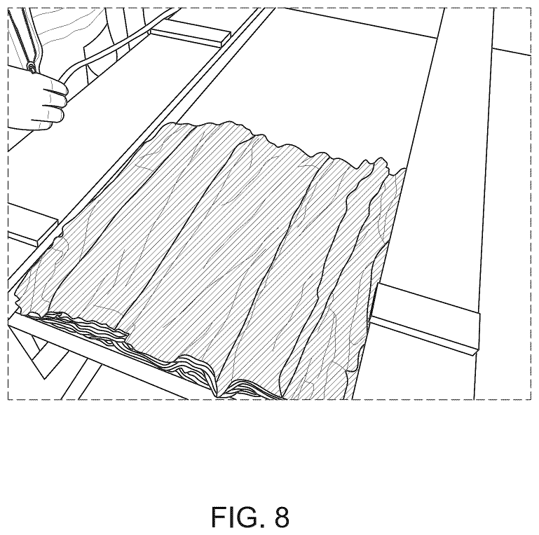

A 32″×18″ stack of 10 layers of embossed tissue paper was measured for dimensions and weighed. Once measured and weighed, the stack was placed between two wooden guides placed 16″ apart to reduce the width of the panel by half. It was then sprayed with 100% Sta-Flo solution and dried by hand with a heat gun at 800° F. on all sides in the same fashion as described above in the Panel Preparation section above. This is shown in FIGS. 7 and 8.

### Prepared Panel

Weights and measurements of each panel as described were taken and compiled into Table 1 below, which indicates the difference in density achieved by narrowing. 2.5 oz/cu ft compared to 0.8, for hand narrowed materials.

TABLE 1
Panel Density Measurement - 50% Width Reduction

| | Thickness | Width | Length | Mass | Density |
|---|---|---|---|---|---|
| | (in) | (in) | (in) | (g) | (oz/ft3) |
| 10 Layers Unembossed | 0.20 | 32 | 15 | 64.00 | 2.5 |
| Stacked Tissue No Starch | | | | | |
| Hand Narrowed | 1.37 | 16 | 15 | 66.00 | 0.8 |
| Narrowed 10 layers | | | | | |
| Starched using 100% | | | | | |
| solution | | | | | |

### Experiment 3

In this example, weights were placed onto 10 layer panels of tissue that are treated with varying % of water (0-100%) of a commercially available starch solution Sta-Flo, and properties tested. Results are shown in Table 2.

It is evident that the higher the % of Sta-Flo, the thicker, more compression resistant and less dense the product is. Effective spring constant represents the ‘push back’ of the panel when force is applied. Of note is that higher solution % yields reduced density, this is important and critical in that reduced density improves insulation performance while exhibiting more loft/thickness. Also of note, is the increased initial thickness and lower density of the panels proportional to increased starch percentage. This advantageous feature demonstrates that stiffer tissue collapses less due to its own weight, therefore providing more loft.

TABLE 2
Range of Improved Stiffness and Density - 10.25″ ×
26″ panel - 10 layer

| | % Concentration of Sta-Flo | | | | |
|---|---|---|---|---|---|
| | 0% | 25% | 50% | 75% | 100% |
| Initial Thickness (in) | 1.6 | 1.7 | 2.2 | 2.1 | 2.3 |
| Compressed Thickness | 0.6 | 0.9 | 1.3 | 1.2 | 1.6 |
| (in) | | | | | |
| Weight of Compression | 8.3 | 8.3 | 8.3 | 8.3 | 8.3 |
| (lbf) | | | | | |
| Compression % | 0.63 | 0.47 | 0.41 | 0.43 | 0.30 |
| Effective Spring | 8.3 | 10.3 | 9.2 | 9.2 | 11.8 |
| Constant (lbf/in) | | | | | |
| Initial Mass (g) | 316 | 315 | 316 | 315 | 313 |
| Post Dry Mass (g) | 316 | 321 | 326 | 333 | 324 |
| Density (lbm/ft3) | 2.82 | 2.70 | 2.12 | 2.27 | 2.01 |

### Experiment 4

### Deflection as a Percentage of Panel Thickness-Force Applied to Panel Face

Testing was performed to measure how much a panel reduces in thickness when a force using varying amounts of weight is applied to the face of the panel when it is placed on a flat surface. The test compares an unstarched to starched panel. The difference in compression resistance ranges from 1 to 2%. Results are shown in Table 3.

TABLE 3
Unstarched vs. 100% Starch solution

| F (lbf) | Unstarched - | Starched |
|---|---|---|
| 10.00 | 13% | 11% |
| 9.04 | 12% | 11% |
| 8.07 | 12% | 11% |
| 7.10 | 11% | 10% |
| 6.13 | 11% | 10% |
| 5.16 | 10% | 9% |
| 4.19 | 9% | 8% |
| 3.22 | 9% | 7% |
| 2.25 | 6% | 6% |
| 1.29 | 3% | 4% |
| 0.32 | 0% | 0% |

### Experiment 5

### Deflection Testing—Side Load

Testing was performed to measure how much a panel reduces in thickness when a force using varying amounts of weight is applied to the side of the panel when it is held upright. The test compares an unstarched to starched panel. The difference in compression resistance ranges from 9 to 24% improved resistance to compression. Results are shown in Table 4.

TABLE 4

% starch saturation

| F (lbf) | 0% | 25% | 50% | 75% | 100% |
|---|---|---|---|---|---|
| 0.03 | 100% | 100% | 100% | 100% | 100% |
| 1.97 | 74% | 86% | 86% | 90% | 91% |
| 3.91 | 63% | 82% | 81% | 86% | 86% |
| 5.85 | 58% | 80% | 76% | 76% | 82% |

### Experiment 6

Testing was performed to evaluate panel memory (bounce back) after repeated force is applied to panels using a weight. Results are shown in Table 5.

TABLE 5
Panel Memory - Cyclic Loading (8.276 lbf load)

| | % Reduction in Initial Thickness | | | | |
|---|---|---|---|---|---|
| | 0% | 25% | 50% | 75% | 100% |
| Cycles | Stay-Flo | Stay-Flo | Stay-Flo | Stay-Flo | Stay-Flo |
| 0 | 0.0% | 0.0% | 0.0% | 0.0% | 0.0% |
| 1 | 20.8% | 4.7% | 4.3% | 7.6% | 7.2% |
| 2 | 27.5% | 6.5% | 6.3% | 8.7% | 8.7% |
| 3 | 21.8% | 6.4% | 7.3% | 6.9% | 9.5% |
| 4 | 29.4% | 9.0% | 8.5% | 5.1% | 8.1% |
| 5 | 30.1% | 8.5% | 8.7% | 5.5% | 10.1% |
| 6 | 29.3% | 8.3% | 8.7% | 4.9% | 9.8% |
| 7 | 30.4% | 8.7% | 10.2% | 5.1% | 10.1% |
| 8 | 30.4% | 8.9% | 9.4% | 6.1% | 10.3% |
| 9 | 32.5% | 9.9% | 7.1% | 6.1% | 9.8% |

The conclusion is that the starch solutions yield improved memory, however, a 50 and 75% solution are better than 100% solution, possibly because they exhibit less structure breakage when force is applied instead exhibiting more flexing.

We claim:

1. A method for producing insulation panels for shipping cartons, comprising:
narrowing a web of tissue paper selected from cellulosic or synthetic tissue paper, having an initial volume and thickness, to increase the volume and thickness of the web, thereby forming narrowed tissue paper web, sectioning a desired length of the web and enveloping such a narrowed structure with a material with lesser absorbency than the tissue paper.

2. A method for producing insulation panels for shipping cartons, comprising:
narrowing a web of tissue paper selected from cellulosic or synthetic tissue paper having an initial volume and thickness to increase its volume and thickness, thereby forming narrowed tissue paper web, having an initial firmness;
optionally pre-drying said treated tissue paper to a final moisture level of 0.1-0.6% (to maximize absorption of a desirable solution);
treating the narrowed tissue paper with a stiffening agent to increase firmness, thereby forming a treated tissue paper having a form, stiffness, and a firmness a minimum of 10% greater than the initial firmness; and
drying said treated tissue paper to a final moisture level of 0.5 to 6.5%, while retaining its form and stiffness, thereby forming a dried, treated tissue paper having a top surface and a bottom surface.

3. The method of claim 1 wherein more than one web of tissue is individually narrowed and before stacking.

4. The method of claim 1 where the drying is conducted at a temperature from 220 to 1500 for a time of 0.01 to 3 seconds.

5. The method of claim 1 where drying is conducted by forced air.

6. The method of claim 1, further comprising adhering a sheet of material to one or both surfaces of the dried, treated tissue paper, thereby forming covered tissue paper.

7. The method of claim 1, where said stiffening agent is selected from the group consisting of potato starch, corn starch, tapioca starch, any stiffening agent that can be applied using a solvent and mixtures thereof.

8. The method of claim 1, wherein the dried and treated tissue paper is wrapped in a heat-sealable paper.

9. The method of claim 1 wherein the said panel is made using at least two separate webs of tissue paper are stacked on top of one another after narrowing.

10. The method of claim 1 wherein the tissue paper is treated to increase volume prior to the narrowing step.

11. The method of claim 6, wherein the covered tissue paper is wrapped in a heat sealable paper selected from chemically-treated paper and polyethylene coated paper.

12. An insulation panel made by the method process of claim 1.

13. The insulation panel of claim 12, wherein said panel is curbside recyclable and pulpable and/or from 75 to 85% of fiber can be reclaimed when introduced into a recycling process.

14. A lined shipping carton comprising the insulation panel of claim 12.

15. The insulation panel of claim 12, wherein every component contains cellulose fiber, whether it is coated or treated with other material.

16. A shipping carton comprising the insulation panel of claim 12.

17. A cushioning material comprising insulation panels made using the method of claim 1.

18. The method of claim 1 comprising including a reflective material, on a surface or between the layers of the narrowed tissue.

19. The method of claim 18 where the reflective material is unattached to the narrowed tissue.

20. The method of claim 18 where the covered, narrowed material is creased to facilitate bending.
